(19) United States
(12) Patent Application Publication
(10) Pub. No.: US 2008/0160442 A1
(43) Pub. Date: Jul. 3, 2008

(54) Hybrid toner and method of preparing the same

(75) Inventors: In Kim, Suwon-si (KR); Kyung-yol Yon, Seongnam-si (KR); Sang-eun Shim, Nam-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 12/003,211

(22) Filed: Dec. 20, 2007

(30) Foreign Application Priority Data
Jan. 2, 2007 (KR) 10-2007-0000302

(51) Int. Cl. G03G 9/087; G03G 15/00

(52) U.S. Cl. 430/109.3; 430/109.4; 430/137.14; 399/159

(57) ABSTRACT

A hybrid toner and a method of preparing the toner are provided. The hybrid toner is of a core-shell type, and as such the storage characteristics of the toner are improved and a toner blocking phenomenon and image contamination that are caused by dispersion of waxes or colorants onto the surface of the outer layer of toner particles are prevented. The hybrid toner includes particles include: a core of about 100 parts by weight of a polyester-based resin, about 1-20 parts by weight of a wax, about 0.1-10 parts by weight of a colorant and about 0.1-10 parts by weight of a charge control agent; and a shell of about 5-500 parts by weight of a vinyl-based resin, about 0.1-10 parts by weight of silica, about 0.1-5 parts by weight of a metal oxide and about 0.1-10 parts by weight of polymer beads.

### CROSS-REFERENCE TO RELATED PATENT APPLICATION

This application claims the benefit under 35 U.S.C. §119(a) of Korean Patent Application No. 10-2007-0000302, filed on Jan. 2, 2007, in the Korean Intellectual Property Office, the disclosure of which is incorporated herein by reference in its entirety.

### BACKGROUND OF THE INVENTION

1. Field of the Invention

The present invention relates to a hybrid toner for use in an electrostatic electrophotographic developing system and to a method of preparing the hybrid toner. More particularly, the invention is directed to a hybrid toner that has particles having a core-shell type structure, wherein a toner blocking phenomenon and image contamination that are caused by the dispersion of waxes or colorants onto the surface of the outer layer of toner particles are prevented. The hybrid toner exhibits improved storage stability characteristics of the toner. The invention is also directed to a method of preparing the same.

2. Description of the Related Art

In an electrophotographic process or an electrostatic recording process, a developer used to form an electrostatic image or an electrostatic latent image may be a two-component developer, formed of toner and carrier particles, or a one-component developer, formed of toner only. The one-component developer may be a magnetic one-component developer or a nonmagnetic one-component developer. Plasticizers such as colloidal silica are often added independently into the nonmagnetic one-component developer to increase the flowability of the toner. Generally, coloring particles obtained by dispersing a colorant, such as carbon black, or other additives in a binding resin are used in the toner.

Methods of preparing toner include pulverization or polymerization methods. In the pulverization method, toner is obtained by melting and mixing synthetic resins with colorants and, if needed, other additives, pulverizing the mixture and sorting the particles until particles of a desired size are obtained. However, in dry pulverization, when wax is included in an amount greater than about 2.5 weight %, there is a negative impact on the durability and storage stability of the toner. Therefore, increasing the amount of wax in order to prevent offset and improve fixation of toner onto paper is undesirable. In addition, when toner is prepared using a pulverization method, it is inevitable that a wax that is embedded in the particles obtained by the pulverization method outwardly protrudes. This causes a toner blocking phenomenon, resulting in low image quality and poor storage stability of toner.

Meanwhile, in the polymerization method, a polymerizable monomer composition is manufactured by uniformly dissolving or dispersing a polymerizable monomer, a pigment, a polymerization initiator and, if needed, various additives such as a cross-linking agent and an antistatic agent. Next, the polymerizable monomer composition is dispersed in an aqueous dispersive medium which includes a dispersion stabilizer using an agitator to shape minute liquid droplet particles. Subsequently, the temperature is increased and suspension polymerization is performed to obtain polymerized toner having coloring polymer particles of a desired size. In particular, there is a method of preparing toner by forming core particles using a vinyl-based monomer and an initiator, and then forming a core-shell by polymerizing a vinyl-based monomer having the same hydrophilic property as that of the core particles and a higher glass transition temperature (Tg) than that of the core particles. However, in order to maintain the structure of the core-shell and improve the storage of toner, the core-shell has to be thick.

In particular, in electronic photocopiers, laser beam printers, electrostatic recording apparatuses or the like in which images are formed using electrophotography, electrostatic recording or the like, toner used to develop an electrostatic image requires a developer for fixation of toner onto paper at a low temperature required for high speed devices.

### SUMMARY OF THE INVENTION

The present invention provides a hybrid toner used to develop an electrostatic image, where a toner blocking phenomenon and offset are prevented, and where fixation of toner onto paper at a low temperature through improved fixation is possible and in which storage stability of toner is excellent.

The present invention also provides a method of preparing the toner.

The present invention also provides a method of forming a high quality image using the toner where the fixation of the toner onto paper occurs at a low temperature.

The present invention also provides an apparatus for forming a high quality image comprising the toner where the fixation of the toner onto paper is possible at a low temperature.

According to an aspect of the present invention, a hybrid toner is provided comprising: a core comprising about 100 parts by weight of a polyester-based resin, about 1-20 parts by weight of wax, about 0.1-10 parts by weight of a colorant and about 0.1-10 parts by weight of a charge control agent; and a shell comprising about 5-500 parts by weight of a vinyl-based resin, about 0.1-10 parts by weight of silica, about 0.1-5 parts by weight of a metal oxide and about 0.1-10 parts by weight of polymer beads.

According to another aspect of the present invention, a method of preparing a hybrid toner is provided, comprising: mixing a polyester-based resin, wax, a colorant and a charge control agent to form core particles; dispersing the core particles in a water-based solvent to form a core dispersion solution; adding a solution obtained by dissolving a vinyl-based resin in a non-aqueous solvent to the core dispersion solution to allow the vinyl-based resin to precipitate in the core dispersion solution; absorbing the precipitated vinyl-based resin onto a surface of the core particles to form a core-shell structure; and externally adding silica, a metal oxide and polymer beads to the core-shell structure.

According to another aspect of the present invention, an image forming method is provided comprising: forming a visible image by disposing the hybrid toner as described above on a surface of a photoreceptor on which an electrostatic latent image is formed; and transferring the visible image to a transfer medium.

According to another aspect of the present invention, an image forming apparatus is provided comprising: an organic photoreceptor; a unit for charging a surface of the organic photoreceptor; a unit for forming an electrostatic latent image on a surface of the organic photoreceptor; a unit for containing the hybrid toner as described above; a unit for supplying the toner to the surface of the organic photoreceptor to develop the electrostatic latent image on the surface of the organic photoreceptor into a toner image; and a unit for transferring the toner image on the surface of the organic photoreceptor to a transfer medium.

These and other aspects of the invention will become apparent from the following detailed description of the invention which in conjunction with the annexed drawing disclose various embodiments of the invention.

### BRIEF DESCRIPTION OF THE DRAWING

The above and other features and advantages of the present invention will become more apparent by describing in detail exemplary embodiments thereof with reference to FIG. 1:

FIG. 1 illustrates an image forming apparatus including toner prepared using the method of the present invention, according to an embodiment of the present invention.

### DETAILED DESCRIPTION OF THE INVENTION

The present invention will now be described more fully with reference to the accompanying drawings, in which exemplary embodiments of the invention are shown.

The present invention provides a hybrid toner wherein a toner blocking phenomenon and offset are prevented. The hybrid toner further has an improved fixation of toner onto paper at a low temperature, and has excellent storage stability. Therefore, the hybrid toner can be used in developing an electrostatic image in electronic photocopiers, laser beam printers, electrostatic recording apparatuses or the like in which images are formed using electrophotography, electrostatic recording or the like.

The hybrid toner includes particles comprising: a core comprising a polyester-based resin; and a shell comprising unsaturated vinyls such as a styrene-based resin or an acrylate-based resin, which is formed on the outer surface of the core, such that the hybrid toner has a core-shell structure. The core can comprise a polyester-based resin with no externally added additives, prepared by a conventional pulverization process, or a polyester-based core formed using a polymerization method.

The core-shell structure can be formed using the difference of the solubility in a solvent of the polyester-based resin and the stability of the vinyl-based resin. That is, when core particles comprising the polyester-based resin are dispersed in a water-based solvent to prepare a core dispersion solution, and then a solution in which the vinyl-based resin is dissolved in a non-aqueous solvent is added to the core dispersion solution, the vinyl-based polymer resins that is insoluble in the water-based solvent forming the dispersion solution is extracted in a precipitation form. Thus, the vinyl-based resin is precipitated and absorbed onto a surface of core particles comprising the polyester-based resin to form a shell on the polyester core particles.

In this way, fixation of toner onto paper at a low temperature and gloss suitable for graphic printing can be obtained by introducing the polyester-based resin to the core of the hybrid toner. In addition, the surface of the core is encapsulated by a shell comprising a vinyl-based resin, and thus toner particles can have improved storage stability and charging properties.

The polyester-based resin contained in the core includes a polyester moiety, and may have at least one reactive group selected from a vinyl group, an acrylate group and a methacrylate group. For example, the polyester-based resin including at least one reactive group is selected from the group consisting of crystalline polyester resins such as ε-caprolactone, butyrolactone, caprolactam-lactone copolymer, styrene, divinylbenzene, n-butylacrylate, methacrylate and acrylate. The polyester resins can be used alone or as a combination of at least two of the polyester-based resins. The crystalline polyester resin has a melting point in the range of 30-70° C.

The polyester-based resin may have a number average molecular weight of about 1,000-120,000, and preferably about 1,000-50,000. When the number average molecular weight of the polyester-based resin is less than 1000, the durability of toner is reduced. When the number average molecular weight of the polyester-based resin is greater than 120,000, fixation ability of toner onto paper is reduced.

The polyester-based resin forms a core together with agents such as a wax, a release agent, a colorant, a charge control agent or the like.

The wax contained in the core of the toner may be appropriately selected according to the purpose of the final toner. Examples of the wax that can be used include polyethylene-based wax, polypropylene-based wax, silicone wax, paraffin-based wax, ester-based wax, carnauba wax and metallocene wax, but are not limited thereto.

The wax used in the toner according to the present invention may particularly have a melting point in the range of about 50-150° C. The wax having the melting point as described above can effectively exhibit releasing properties. The higher the melting point of the wax, the lower the dispersion of toner particles. The lower the melting point of the wax, the higher the dispersion of toner particles. However, the melting point of the wax may be in the range of about 50-150° C., taking into consideration inner environmental factors of an electrophotographic device in which the toner is actually used and fixation of final printed images. Components of the wax physically adhere to toner particles, but may not covalently bind with the toner particles. The wax is fixed on a final image receptor at a low temperature, and the toner having excellent durability of final images and excellent rubfastness is obtained.

The amount of the wax in the toner may be preferably about 1-20 parts by weight based on 100 parts by weight of the polyester-based resin, and more preferably about 1-10 parts by weight. When the amount of the wax is less than 1 part by weight, the releasing properties of the toner decreases. When the amount of the wax is greater than 20 parts by weight, the durability of toner is reduced.

The release agent that is embedded in the core of the toner can be used to protect a photoreceptor and prevent deterioration of developing, thereby obtaining a high quality image. A release agent used in the present invention may be a high purity solid fatty acid ester material. Examples of the release agent include low molecular weight polyolefins such as low molecular weight polyethylene, low molecular weight polypropylene, low molecular weight polybutylenes, etc.; paraffin wax; multi-functional ester compound, and the like. The release agent used in the present invention may be a multifunctional ester compound composed of an alcohol having three or more functional groups and a carboxylic acid. The amount of the release agent may be about 0.1-10 parts by weight based on 100 parts by weight of the polyester-based resin. When the amount of the release agent is greater than 10 parts by weight, the durability of the toner is reduced. When the amount of the release agent is less than 0.1 parts by weight, the releasing properties of the toner decreases.

The charge control agent that is embedded in the core of the toner may be preferably selected from the group consisting of a salicylic acid compound containing metals such as zinc, aluminum, boron complexes of bis diphenyl glycolic acid, and silicate. More preferably, dialkyl salicylic acid boron, boro bis(1,1-diphenyl-1-oxo-acetyl potassium salt), or the like can be used. The amount of the charge control agent may be about 0.1-5 parts by weight based on 100 parts by weight of the polyester-based resin. When the amount of the charge control agent is less than 0.1 parts by weight, the charging of toner deteriorates. When the amount of the charge control agent is greater than 5 parts by weight, the developing of toner is not properly performed due to excessive discharge.

A colorant that is embedded in the core of the toner can be carbon black or aniline black in the case of black toner. The hybrid toner is efficient for preparing color toner. For color toner, carbon black is used as a black colorant, and yellow, magenta, and cyan colorants are further included for colored colorants.

For the yellow colorant, a condensation nitrogen compound, an isoindolinone compound, anthraquinone compound, an azo metal complex, or an allyl imide compound can be used. For example, C.I. pigment yellow 12, 13, 14, 17, 62, 74, 83, 93, 94, 95, 109, 110, 111, 128, 129, 147, 168, 180, and the like can be used.

For the magenta colorant, a condensation nitrogen compound, an anthraquinone, quinacridone compound, base dye lake compound, naphthol compound, benzo imidazole compound, thioindigo compound, or perylene compound can be used. For example, C.I. pigment red 2, 3, 5, 6, 7, 23, 48:2, 48:3, 48:4, 57:1, 81:1, 122, 144, 146, 166, 169, 177, 184, 185, 202, 206, 220, 221, or 254, and the like can be used.

For the cyan pigment, copper phthlaocyanine compound and derivatives thereof, anthraquinone compound, or base dye lake compound can be used. For example, C.I. pigment blue 1, 7, 15, 15:1, 15:2, 15:3, 15:4, 60, 62, or 66, and the like can be used.

Such colorants can be used alone or in a combination of two or more colorants, and are selected in consideration of color, chromacity, luminance, resistance to weather, dispersion property in toner, etc.

The amount of the colorants can be any amount that sufficiently colors toner, and may be about 0.1-10 parts by weight based on 100 parts by weight of the polyester-based resin. When the amount of the colorant is less than 0.1 parts by weight, the coloring effect of the colorant is insufficient. When the amount of the colorant is greater than 10 parts by weight, the cost for preparing toner is increased, and the sufficient amount of friction charging can not be obtained.

To form a hybrid toner comprising particles having a core-shell structure according to the present invention, a shell comprising a vinyl-based resin is formed on an outer surface of the core. The core-shell structure can be formed by the solubility difference as described above. That is, when core particles comprising the polyester-based resin are dispersed in a water-based solvent to prepare a core dispersion solution, and then a solution in which the vinyl-based resin is dissolved in a non-aqueous solvent is added to the core dispersion solution, the vinyl-based polymer resin that is insoluble in the water-based solvent forming the dispersion solution is extracted in a precipitation form. Thus, the vinyl-based resin is absorbed onto a surface of core particles comprising the polyester-based resin to form a shell.

The vinyl-based resin that forms the shell may be a polymer comprising at least one component selected from the group consisting of styrene-based repeating units such as styrene, vinyl toluene, α-methyl styrene; (meth)acrylate-based repeating units such as (meth)acrylate, methyl(meth)acrylate, ethyl(meth)acrylate, propyl(meth)acrylate, butyl(meth)acrylate, 2-ethylhexyl(meth)acrylate, dimethylaminoethyl(meth)acrylate, (meth)acrylonitrile, (meth)acrylamide or the like; ethylenically unsaturated monoolefin-based repeating units such as ethylene, propylene, butylenes; halogenated vinyl-based repeating units such as vinyl chloride, vinylidene chloride, vinyl fluoride; vinyl ester-based repeating units such as vinyl acetate, vinyl propionate; vinyl ether-based repeating units such as vinyl methyl ether, vinyl ethyl ether; vinyl ketone-based repeating units such as vinyl methyl ketone, methyl isoprophenyl ketone; and nitrogen-containing vinyl-based repeating units such as 2-vinylpyridine, 4-vinylpyridine, N-vinyl pyrrolidone, or mixtures of at least two of the polymers.

The vinyl-based resin can be in an appropriate amount with respect to the weight of the core. In particular, the amount of the vinyl-based resin may be about 5-500 parts by weight based on 100 parts by weight of the polyester-based resin, and preferably about 100-250 parts by weight. When the amount of the vinyl-based resin is less than 5 parts by weight, the formation of the shell is insufficient. When the amount of the vinyl-based resin is greater than 500 parts by weight, the thickness of the shell excessively becomes thicker.

The shell of the particles that constitute the hybrid toner can further include a variety of externally added components, using the vinyl-based resin as a main component. The externally added components can be silica, a metal oxide, polymer beads or the like.

The amount of the silica may be about 0.1-10 parts by weight based on 100 parts by weight of the polyester-based resin. When the amount of the silica is less than 0.1 parts by weight, the fluidity of toner is reduced. When the amount of the silica is greater than 10 parts by weight, image contamination occurs and images are unsatisfactorily developed.

The silica is commonly used as a dehumidifying agent, but the function of the silica can depend on the particle size thereof. A silica having a primary particle having a size of approximately 30 nm or more refers to a large-particle silica, and a silica having a primary particle having a size of less than 30 nm refers to a small-particle silica.

The term “primary particle” as used herein refers to a unit particle of a compound in which polymerization, bonding or the like does not occur. The small-particle silica is mainly added in order to improve the fluidity of toner particles. The large-particle silica is added in order to charge the toner particles. The silica may comprise the small-particle silica and the large-particle silica in a predetermined amount ratio. That is, the amount of a small-particle silica having a primary particle size in the range of about 5-20 nm may be 0.1-5 parts by weight based on 100 parts by weight of the polyester-based resin. On the other hand, the amount of a large-particle silica having a primary particle size in the range of about 30-200 nm may be 0.1-5 parts by weight based on 100 parts by weight of the polyester-based resin.

The primary particle size of the small-particle silica and large-particle silica that are included in the externally added agents of the hybrid toner is determined by compatibility with toner particles and the size of the toner particles themselves.

When the total amount of the silica is less than 0.1 part by weight based on 100 parts by weight of the polyester-based resin, the fluidity and charging of toner, which are obtained by silica, are unexpected. When the total amount of the silica is greater than 10 parts by weight based on 100 parts by weight of the polyester-based resin, the charging is excessive, and thus the amount of charging toner particles can not be adjusted. Therefore, the total amount of the silica may be an appropriate amount, considering the problems as mentioned above.

The metal oxide, which is one of the externally added agents includes titanium oxide. The amount of the titanium oxide may be about 0.1-5 parts by weight based on 100 parts by weight of the polyester-based resin. The titanium oxide can exist in a form having various acid values in addition to the form of TiO₂. TiO₂ is the most common form. The titanium oxide is dissolved in alkali to become alkali titanate. The titanium oxide is mostly used as a white pigment (titan white) having a high hiding power, and used in magnetic raw materials, an abrasive, medicines, cosmetics or the like. The titanium oxide adjusts the excessive charging occurring when only silica is used as an externally added agent. The titanium oxide may be surface-treated with alumina and organo polysiloxane, and may have a primary particle size in the range of about 10-200 nm. The particle size of the titanium oxide can be determined by the size of toner particles and compatibility with toner particles as described above in the case of silica. The surface-treated titanium oxide may have a BET surface area of 20-100 m²/g.

The shell of the particles of the hybrid toner can further include polymer beads as an externally added agent in addition to the metal oxide and silica as described above. A styrene-based resin, methacrylic acid methyl ester, a styrene-methacrylic acid methyl ester copolymer, an acryl-based resin, an acryl-styrene copolymer or the like can be alone or in combination as the polymer beads. The polymer beads are manufactured by a polymerization process such as suspension polymerization or the like, thereby are formed to be generally spherical. The particle size of the polymer beads can be various sizes in the range of submicrons to tens of microns. The polymer beads can be contained in the shell, having an amount of about 0.1-3 parts by weight based on 100 parts by weight of the polyester-based resin. When the amount of the polymer beads is less than 0.1 parts by weight, the charging is reduced. When the amount of the polymer beads is greater than 3 parts by weight, image contamination occurs.

The hybrid toner can further include various added agents in order to improve the functionality of the hybrid toner besides the added agents as described above. For example, an UV stabilizer, a mold inhibitor, bactericide, fungicide, an antistatic agent, a gloss modifying agent, antioxidant, an anti-caking agent such as silane or silicon-modified silica particles, or the like may be selected alone or in a combination of at least the two types can be added to the hybrid toner as added agents. The amount of the added agent may be about 0.1-10 parts by weight based on 100 parts by weight of the polyester-based resin.

The hybrid toner may have an average particle diameter of about 4.0-12.0 μm.

The hybrid toner as described above can be prepared by the following processes.

First, a single polyester-based resin or a blend of two polyester-based resins as a binder for a toner are mixed with wax, a colorant, a charge control agent and the like as an agent, and the mixture is melted and mixed in an extruder, and then cooled, solidified, pulverized and sorted to form a core particle. The obtained core is dispersed in a water-based solvent to form a core dispersion solution. A vinyl-resin is dissolved in a non-aqueous solvent to prepare a solution. The solution comprising the vinyl-based resin is then slowly added to the core dispersion solution to precipitate the vinyl-based resin. Then, the precipitated vinyl-based resin is absorbed onto a surface of core particles comprising the polyester-based resin to form a shell. As a result, a core-shell structure is formed. Subsequently, various external additives, for example, silica, a metal oxide, polymer beads or the like are added to the hybrid toner, which has particles having the core-shell structure. As a result, a hybrid toner according to the present invention is prepared.

In terms of any kinds of components used in the method of preparing a hybrid toner according to the present invention, a polyester-based resin, wax, a colorant, a charge control agent, a polymerizable monomer, silica, a metal oxide, polymer beads and the like as described above can be used with an amount ratio described as above.

First, the process of forming a core includes melting and mixing materials used to form a core in an extruder, and then cooling, pulverizing and sorting the resultant mixture. The extruder and the melting/mixing process are known to those of ordinary skill in the art, and are not particularly limited. The pulverizing process can comprise two operations. The first operation is to pulverize cooled particles into intermediate-sized particles having a diameter of several mms. The second operation is to finely pulverize the pulverized particles into small-sized particles having a diameter of several-tens of μm. The finely pulverized particles are sorted to particles having a diameter of about 4-10 μm, and preferably about 6-8 μm.

The polyester-based resin, which is one of materials used to form a core, can be one particulate-type resin or a blend of at least two polyester-based resins, and also can be a polyester-based resin formed by polymerizing polyhydric alcohols or derivatives thereof and dicarboxylic acid compounds. The polyhydric alcohols may be a diol, and the equivalence ratio of the polyhydric alcohols and the dicarboxylic acid compounds may be in the range of 1:1-1:2. The diol can be ethylene glycols, propylene glycols or the like. The dicarboxylic acid compounds can be terephthalate, an isophthalic acid, an adipic acid, or the like.

The polyester-based resin can be used in a particulate form together with materials used to form a core, such as a colorant, a pigment, wax or the like to be pulverized and sorted. However, core particles can be formed by dispersing the polyester-based resin in an organic solvent with a dispersant, mixing the resultant mixture with extra materials used to form a core, and then adding a water-based solvent such as water or the like to the mixture to precipitate core particles. When the latter process is used, fine particles are formed in a mixed solution, and thus pulverization and sorting processes are not required. The organic solvent dispersing the polyester-based resin can be methylene chloride, tetrahydrofurane, dimethylsulfonic oxide or the like.

The core obtained in the process of forming a core is dispersed in a water-based solvent to form a core dispersion solution. A solution obtained by dissolving a vinyl-based resin in a non-aqueous solvent is slowly added to the core dispersion solution. The vinyl-based resin is insoluble in the core dispersion solution comprising the water-based solvent, and thus the vinyl-based resin exists in a precipitation form. The extracted vinyl-based resin is immediately absorbed on a surface of core particles existing in the core dispersion solution to form a shell structure. As a result, a core-shell structure is formed.

The core particles existing in the core dispersion solution can be formed to have a concentration of about 5-50 weight % with respect to the total weight of the water-based solvent, and preferably about 5-15 weight %. The vinyl-based resin may have a concentration of about 5-50 weight % with respect to the total weight of the non-aqueous solvent, and preferably about 5-15 weight %.

The water-based solvent used to form a core dispersion solution in the process of forming a shell can be any water-based solvent that does not dissolve the core particles comprising the polyester-based resin. The water-based solvent refers to a solvent itself having electric charges, and does not refer to a solvent comprising only water. Examples of the water-based solvent include water, alcohols or mixtures thereof. The amount of the water-based solvent may be any amount that sufficiently disperses the core particles, and is not particularly limited. The water-based solvent can be a mixture of water and methanol, ethanol, propanol or butanol.

The non-aqueous solvent used in the process of forming a shell refers to a general organic solvent, and can be any solvent that can dissolve the vinyl-based resin. However, the non-aqueous solvent may be a compatible organic solvent that can mix with the water-based solvent, for example, benzene, toluene, tetrahydrofurane, methylethylketone, methylene chloride, ethyl acetate or the like.

The dispersant used in the process of forming a shell makes it easy for precipitated vinyl-based resins to be absorbed onto the surface of the core, without being agglomerated with each other. The dispersant can be any dispersant known to those of ordinary skill in the art. A reactive dispersant can be alkyl polyethoxy acrylate, alkyl polyethoxy methacrylate, aryl polyethoxy acrylate, aryl polyethoxy methacrylate or the like. Preferably, the dispersant may be HS-10, RN-10 (Product name, manufactured by Dai-ichi Kogyo Seiyaku Co., Ltd) or the like. The dispersant can have an appropriate amount known to those of ordinary skill in the art.

The macromonomers used in the process of forming a shell can stabilize particles during or after the process. The macromonomers are amphipathic materials having both a hydrophilic group and a hydrophobic group, and may be polymers or oligomers having at least one reactive functional group. The hydrophilic group of the macromonomers reacts with a medium to improve the water dispersion of the macromonomers, and the hydrophobic group thereof exists on the surface of toner particles, thereby being able to facilitate an emulsion polymerization reaction. The hydrophilic and hydrophobic groups binds with the polymerizable monomer by various methods such as graftization, branched, cross-linking bonding or the like, thereby being able to form copolymers. The macromonomers can improve the durability of toner particles and anti-offset properties. In addition, the macromonomers form a stable micelle in the emulsion polymerization reaction, thereby being able to act as a stabilizer. The amount of the macromonomers may be about 0.1-100 parts by weight based on 100 parts by weight of the polymerizable monomer.

The weight average molecular weight of the macromonomers may be about 100 to 100,000, preferably about 1000 to 10,000. When the weight average molecular weight of the macromonomers is less than 100, the physical properties of the toner are not improved or the toner cannot function efficiently as a stabilizer. When the weight average molecular weight of the macromonomers is greater than 100,000, the reaction conversion rate may be lowered.

The macromonomers may be a material selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol(PEG)-hydroxyethylmethacrylate, hexa functional polyester acrylate, dendritic polyester acrylate, carboxy polyester acrylate, fatty acid modified epoxy acrylate, and polyester methacrylate, but is not limited thereto.

The stabilizer used in the process of forming a shell stabilizes particles during or after the process. Examples of the stabilizer include poly(vinylalcohol), poly(vinylpyrrolidone), hydroxyl propylcellulose, poly(acrylic acid) and the like. The amount of the stabilizer may be about 0.1-100 parts by weight based on 100 parts by weight of the polymerizable monomer.

The present invention also provides toner prepared using the method according to the present invention as described above.

The present invention also provides an image forming method including: forming a visible image by disposing toner on a surface of a photoreceptor on which an electrostatic latent image is formed; and transferring the visible image to a transfer medium, wherein the particles of the toner have a core-shell structure obtained using a method of preparing toner according to the present invention as described above wherein the core comprises a polyester-based resin and the shell comprises a vinyl-based resin.

An exemplary electrophotographic image forming process includes charging, exposure to light, developing, transferring, fixing, cleaning, and antistatic process operations, and a series of processes of forming images on a receptor.

In the charging process, a photoreceptor is covered with electric charge of desired polarity, negative or positive charges, by a corona or a charge roller. In the light exposing process, an optical system, conventionally a laser scanner or an array of diodes, selectively discharges the charged surface of the photoreceptor in an imagewise manner corresponding to a final visual image formed on a final image receptor to shape a latent image. Electromagnetic radiation that can be referred to as “light” includes infrared radiation, visible light, and ultraviolet radiation.

In the developing process, appropriate polar toner particles generally contact the latent image of the photoreceptor, and conventionally, an electrically-biased developer having identical potential polarity to the toner polarity is used. The toner particles move to the photoreceptor and are selectively attached to the latent image by electrostatic electricity, and shape a toner image on the photoreceptor.

In the transferring process, the toner image is transferred to the final image receptor from the photoreceptor, and sometimes, an intermediate transferring element is used when transferring the toner image from the photoreceptor to aid the transfer of the toner image to the final image receptor.

In the fixing process, the toner image of the final image receptor is heated and the toner particles thereof are softened or melted, thereby fixing the toner image to the final image receptor. Another way of fixing is to fix toner on the final image receptor under high pressure with or without the application of heat. In the cleaning process, remaining toner on the photoreceptor is removed. Finally, in the antistatic process, charges of a mediumn/body of the photoreceptor are exposed to light of a predetermined wavelength band and are reduced to a substantially uniform, low value, and thus the residue of the original latent image is removed, and the photoreceptor is prepared for a next image forming cycle.

The present invention also provides an image forming apparatus including an organic photoreceptor; a unit charging a surface of the organic photoreceptor; a unit forming an electrostatic latent image on a surface of the organic photoreceptor; a unit containing a toner; a unit supplying the toner to the surface of the organic photoreceptor to develop the electrostatic latent image on the surface of the organic photoreceptor into a toner image; and a unit transferring the toner image on the surface of the organic photoreceptor to a transfer medium, wherein the particles of the toner have a core-shell structure obtained using a method of preparing toner according to the present invention as described above wherein the core comprises a polyester-based resin and the shell comprises a vinyl-based resin.

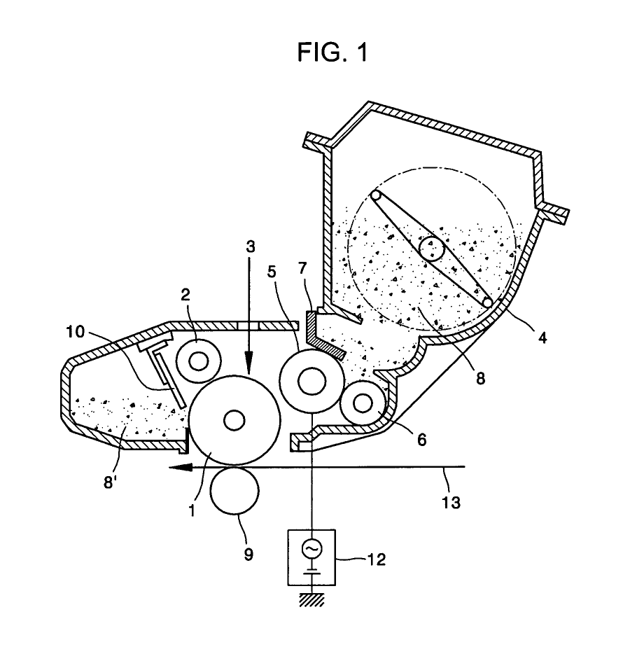

FIG. 1 is a schematic diagram of a non-contact developing type image forming apparatus using a toner prepared using the method according to an exemplary embodiment of the present invention. The operating principles of the image forming apparatus 3 are explained below.

A developer 8, which is a nonmagnetic one-component developer, is supplied from a storage unit 4 to a developing roller 5 through a feeding roller 6 formed of an elastic material such as a polyurethane foam or sponge. The developer 8 supplied to the developing roller 5 reaches a contact point between the developing roller 5 and a developer regulation blade 7 as the developing roller 5 rotates. The developer regulation blade 7 is formed of an elastic material such as metal, rubber, or the like. When the developer 8 passes the contact point between the developing roller 5 and the developer regulation blade 7, the developer 8 is smoothed to form a thin layer that is sufficiently charged. The developing roller 5 which is charged by a charging unit 12 transfers the thin layer of the developer 8 to a developing domain where the thin layer of the developer 8 is developed on the electrostatic latent image of a photoreceptor 1 charged by a charging roller 2, which is a latent image carrier.

The developing roller 5 and the photoreceptor 1 face each other with a constant distance therebetween. The developing roller 5 rotates counterclockwise and the photoreceptor 1 rotates clockwise. The developer 8 transferred to the developing domain forms an electrostatic latent image on the photoreceptor 1 according to the intensity of an electric charge generated due to a difference between an AC voltage superposed with a DC voltage applied to the developing roller 5 and a latent image potential of the photoreceptor 1.

The developer 8 developed on the photoreceptor 1 reaches a transferring device 9 as the photoreceptor 1 rotates. The developer 8 developed on the photoreceptor 1 is transferred through corona discharging or by a roller to a printing paper 13 as the printing paper 13 passes between the photoreceptor 1 and the transferring device 9. The transferring device 9 receives a high voltage with an opposite polarity to the developer 8, and thus forms an image.

The image transferred to the printing paper 13 passes through a fusing device (not shown) that provides high temperature and high pressure, and the image is fused to the printing paper 13 as the developer 8 is fused to the printing paper 13. Meanwhile, the developer 8′ remaining on the developing roller 5 which is not developed is collected by a cleaning blade 10 and transferred back to the feeding roller 6 contacting the developing roller 5. The above processes are repeated.

The present invention will be described in more detail with reference to the examples below, but is not limited thereto. The following examples are for illustrative purposes only and are not intended to limit the scope of the invention.

A polyester-based resin that was used in the following examples was manufactured by Samyang Co., Ltd. TM1 having a glass transition temperature (Tg) of 69° C., a softening temperature (Ts) of 135° C., a Gel amount of 3-5%, a number average molecular weight (Mn) of 8,000-9,000, a molecular weight polydispersity index (MWD) of 7-10, P1 having a glass transition temperature (Tg) of 60° C., a softening temperature (Ts) of 153° C., a Gel amount of 24-26%, a number average molecular weight (Mn) of 5,000-6,000, a molecular weight polydispersity index (MWD) of 7-10, and TLA1 having a glass transition temperature (Tg) of 54° C., a softening temperature (Ts) of 99° C., a Gel amount of 0.0%, a number average molecular weight (Mn) of 4,000-6,000, a molecular weight polydispersity index (MWD) of 2-5 were blended in the mixing ratio of 80:20 (wt. %) and 70:30 (wt. %), respectively and used.

### EXAMPLE 1

A Process of Forming a Polyester Core

88 parts by weight of TM1, 6 parts by weight of polyester wax, 3 parts by weight of carbon black, 3 parts by weight of MPT 313 were premixed in a Henschel mixer. Subsequently, the mixture was extruded in a modular corotating twin screw extruder including two regions of kneading blocks at a supplying speed of 3 rpm, a screw speed of 200 rpm, a screw torque of 80%, a resin temperature of 130-140° C. for an average remaining time of 4 kg/hr. Then, the resultant was cooled and jaw crushed, and pulverized into intermediate-sized particles having a diameter of 1-2 mm using a Bantam Mill, finely pulverized into small-sized particles having a diameter of several to tens of μm in a crushing-sorting device, and then sorted to particles having a diameter of 6-8 μm to prepare a core containing polyester.

A Process of Forming a Core-Shell Structure Using a Polystyrene Resin

10 g of the obtained core containing polyester, which had a particle diameter of 6-8 μm was added to 100 g of a mixed solvent (weight ratio 1:1) of alcohol, which is a solvent that does not solubilize the shell forming material, and water, and then the mixture was stirred at a stirring speed of 500 rpm and dispersed to prepare a core dispersion solution.

Aside from this, polystyrene as a vinyl-based resin was dissolved in toluene to prepare a polystyrene solution having an amount of 10 weight %. The prepared polystyrene solution was then slowly added to the core dispersion solution comprising polyester to precipitate polystyrene. Then, the polystyrene was absorbed onto a surface of core particles comprising the polyester to form a core-shell structure.

A Process of Performing External Addition

1.0 parts by weight of a large-particle silica, 1.0 parts by weight of a small-particle silica, 0.1 parts by weight of TiO₂, and 0.1 parts by weight of melanin-based polymer beads were mixed with 180 parts by weight of the core-shell structure and stirred at 3800 rpm for 5 minutes to prepare a hybrid toner according to the present invention.

### EXAMPLE 2

A Process of Forming a Polyester Core

90 parts by weight of TM1:TLA1 (a weight ratio of 80:20), 5 parts by weight of polyester wax, 3 parts by weight of carbon black, 3 parts by weight of MPT313 were premixed in a Henschel mixer. Subsequently, the mixture was extruded in a modular corotating twin screw extruder including two regions of kneading blocks at a supplying speed of 3 rpm, a screw speed of 200 rpm, a screw torque of 80%, a resin temperature of 130-140° C. for an average remaining time of 4 kg/hr. Then, the resultant was cooled and jaw crushed, and pulverized into intermediate-sized particles having a diameter of 1-2 mm using a Bantam Mill, finely pulverized into small-sized particles having a diameter of several to tens of μm in a crushing-sorting device, and then sorted to particles having a diameter of 6-8 μm to prepare a core containing polyester.

A Process of Forming a Core-Shell Structure Using a Poly(Styrene-Co-Butylacrylate) Resin

10 g of the obtained core containing polyester, which had a particle diameter of 6-8 μm was added to 100 g of a mixed solvent (weight ratio 1:1) of alcohol, which was an insoluble solvent, and water, and then the mixture was stirred at a stirring speed of 500 rpm and dispersed to prepare a core dispersion solution.

Aside from this, a poly(styrene-co-butylacrylate) resin as a vinyl-based resin was dissolved in benzene to prepare a poly(styrene-co-butylacrylate) solution having an amount of 10 weight %. The prepared poly(styrene-co-butylacrylate) solution was then slowly added to the core dispersion solution comprising polyester to precipitate poly(styrene-co-butylacrylate). Then, poly(styrene-co-butylacrylate) was absorbed onto a surface of core particles comprising polyester to form a core-shell structure.

A Process of Performing External Addition

0.8 parts by weight of a large-particle silica, 1.0 part by weight of a small-particle silica, 0.1 parts by weight of TiO₂, 0.3 parts by weight of melanin-based polymer beads were mixed with the core-shell structure and stirred at 3800 rpm for 2 minutes to prepare a hybrid toner according to the present invention.

### EXAMPLE 3

A Process of Forming a Polyester Core

90 parts by weight of TM1:TLA1 (weight ratio of 70:30), 5 parts by weight of polyester wax, 3 parts by weight of carbon black, 2 parts by weight of MPT313 were premixed in a Henschel mixer. Subsequently, the mixture was extruded in a modular corotating twin screw extruder including two regions of kneading blocks at a supplying speed of 3 rpm, a screw speed of 200 rpm, a screw torque of 80%, a resin temperature of 130-140° C. for an average remaining time of 4 kg/hr. Then, the resultant was cooled and jaw crushed, and pulverized into intermediate-sized particles having a diameter of 1-2 mm using a Bantam Mill, finely pulverized into small-sized particles having a diameter of several to tens of μm in a crushing-sorting device, and then sorted to particles having a diameter of 6-8 μm to prepare a core containing polyester.

A Process of Forming a Core-Shell Structure Using a Poly(Styrene-Co-Methacrylate) Resin

10 g of the obtained core containing polyester, which had a particle diameter of 6-8 μm was added to 100 g of a mixed solvent (weight ratio 1:1) of alcohol, which is a solvent that does not solubilize the core-forming material, and water, and then the mixture was stirred at a stirring speed of 500 rpm and dispersed to prepare a core dispersion solution.

Aside from this, a poly(styrene-co-methacrylate) resin as a vinyl-based resin was dissolved in toluene to prepare a poly(styrene-co-methacrylate) solution having an amount of 10 weight %. The prepared poly(styrene-co-methacrylate) solution was then slowly added to the core dispersion solution comprising polyester to precipitate poly(styrene-co-methacrylate). Then, poly(styrene-co-methacrylate) was absorbed onto a surface of core particles comprising polyester to form a core-shell structure.

A Process of Performing External Addition

part by weight of a large-particle silica, 1.0 part by weight of a small-particle silica, 0.3 parts by weight of TiO₂, and 0.3 parts by weight of melanine-based polymer beads were mixed with the core-shell structure and stirred at 2100 rpm for 5 minutes to prepare a hybrid toner according to the present invention.

The hybrid toners having a core-shell structure of Examples 1 through 3 were added to a developer and tested in a contact and non-contact type printer. As a result, although the hybrid toners were printed on 5,000 sheets of papers, images having excellent durability and fixation, and high quality can be obtained.

According to the present invention, there is provided a hybrid toner having a core-shell structure, wherein the core comprises a polyester-based resin, and the shell comprises a vinyl-based resin. Using the hybrid toner having advantages of the two resins, the storage characteristics of toner can be improved and a toner blocking phenomenon and image contamination, which are caused by waxes or colorants that are dispersed in the polyester-based resin being dispersed onto the surface of the outer layer of toner particles, can be prevented. In addition, high quality images through the durability and fixation improved by the introduction of the shell can be obtained.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A hybrid toner comprising:
core particles comprising about 100 parts by weight of a polyester-based resin, about 1-20 parts by weight of a wax, about 0.1-10 parts by weight of a colorant and about 0.1-10 parts by weight of a charge control agent; and
shell particles comprising about 5-500 parts by weight of a vinyl-based resin, about 0.1-10 parts by weight of silica, about 0.1-5 parts by weight of a metal oxide and about 0.1-10 parts by weight of polymer beads.

2. The hybrid toner of claim 1, wherein the polyester-based resin has at least one reactive group selected from the group consisting of a vinyl group, an acrylate group and a methacrylate group.

3. The hybrid toner of claim 1, wherein the polyester-based resin has at least one reactive group selected from the group consisting of ε-caprolactone, butyrolactone, caprolactam-lactone copolymer, styrene, divinylbenzene, n-butylacrylate, methacrylate and acrylate.

4. The hybrid toner of claim 1, wherein the polyester-based resin has a number average molecular weight of about 1000-120,000.

5. The hybrid toner of claim 1, wherein the wax has a melting point of about 50-150° C.

6. The hybrid toner of claim 1, wherein the colorant is carbon black, aniline black, a yellow colorant, a magenta colorant, or a cyan colorant.

7. The hybrid toner of claim 1, wherein the vinyl-based resin is a polymer comprising at least one selected from the group consisting of styrene-based repeating units, (meth)acrylate-based repeating units, ethylenically unsaturated monoolefin-based repeating units, halogenated vinyl-based repeating units, vinyl ester-based repeating units, vinyl ether-based repeating units, vinyl ketone-based repeating units, and nitrogen-containing vinyl-based repeating units, or mixtures thereof.

8. The hybrid toner of claim 1, wherein the silica comprises large-particle silica having particles having a diameter of at least 30 nm and small-particle silica having particles having a diameter of less than 30 nm.

9. The hybrid toner of claim 1, wherein the metal oxide is TiO₂.

10. The hybrid toner of claim 1, wherein the polymer beads are generally spherical shaped and comprise at least one polymer selected from the group consisting of a styrene-based resin, methacrylic acid methyl, a styrene-methacrylic acid methyl copolymer, an acrylate-based resin and an acrylate-styrene copolymer.

11. The hybrid toner of claim 1, wherein the particles of the hybrid toner have an average in the range of about 4.0-12.0 μm.

12. The hybrid toner of claim 7, wherein the styrene-based polymer is selected from the group consisting of styrene, vinyl toluene, and α-methyl styrene, the (meth)acrylate-based polymer is selected from the group consisting of (meth)acrylate, methyl(meth)acrylate, ethyl(meth)acrylate, propyl(meth)acrylate, butyl(meth)acrylate, 2-ethylhexyl(meth)acrylate, dimethylaminoethyl(meth)acrylate, (meth)acrylonitrile, and (meth)acrylamide, the ethylenically unsaturated monoolefin based polymer is selected from the group consisting of ethylene, propylene, and butylenes, the halogenated vinyl-based polymer is selected from the group consisting of vinyl chloride, vinylidene chloride, and vinyl fluoride, the vinyl ester-based polymer is vinyl methyl ether or vinyl propionate, the vinyl ether-based polymer is vinyl methyl ether or vinyl ethyl ester, the vinyl ketone-based polymer is vinyl methyl ketone or methyl isoprophenyl ketone, and the nitrogen-containing vinyl-based polymer is selected from the group consisting of 2-vinylpyridine, 4-vinylpyridine, and N-vinyl pyrrolidone.

13. A method of preparing a hybrid toner, comprising:
mixing a polyester-based resin, wax, a colorant and a charge control agent to form core particles;
dispersing the core particles in a water-based solvent to form a core dispersion solution;
adding a solution obtained by dissolving a vinyl-based resin in a non-aqueous solvent to the core dispersion solution to allow the vinyl-based resin to precipitate in the core dispersion solution;
absorbing the precipitated vinyl-based resin onto a surface of the core particles to form a core-shell structure; and
externally adding silica, a metal oxide and polymer beads to the core-shell structure.

14. The method of claim 13, wherein the forming of the core particles comprises mixing the single polyester-based resin or a blend of at least two polyester resins with the wax, colorant and charge control agent to form a mixture, and then melting and mixing the mixture in an extruder and cooling, solidifying, pulverizing and sorting the resultant product to form the core particles.

15. The method of claim 13, wherein the forming of the core particles comprises mixing a dispersion solution in which the polyester-based resin is dispersed in an organic solvent with the wax, colorant and charge control agent, and then precipitating the mixture by adding to the water-based solvent.

16. The method of claim 13, wherein the water-based solvent is water, alcohol or a mixture thereof.

17. The method of claim 13, wherein the non-aqueous solvent is benzene, toluene, tetrahydroftirane, methylethylketone, methylene chloride, or ethyl acetate.

18. The method of claim 13, wherein the forming of a shell further comprises adding macromonomers, a dispersant, a stabilizer or mixtures thereof.

19. A hybrid toner prepared using a method according to claim 13.

20. An image forming method comprising: forming a visible image by disposing a hybrid toner according to claim 1 on a surface of a photoreceptor on which an electrostatic latent image is formed; and transferring the visible image to a transfer medium.

21. An image forming apparatus comprising: an organic photoreceptor; a unit charging a surface of the organic photoreceptor; a unit for forming an electrostatic latent image on a surface of the organic photoreceptor; a unit for containing a hybrid toner according to claim 1; a unit for supplying the toner to the surface of the organic photoreceptor to develop the electrostatic latent image on the surface of the organic photoreceptor into a toner image; and a unit for transferring the toner image from the surface of the organic photoreceptor onto a transfer medium.
